(19) United States
(12) Patent Application Publication
(10) Pub. No.: US 2026/0062092 A1
(43) Pub. Date: Mar. 5, 2026

(54) Bicycle Pedal Assembly

(71) Applicant: D3 Innovation Inc., Squamish (CA)

(72) Inventors: Peter Skarsgard, Squamish (CA); Jonathan Staples, Squamish (CA)

(21) Appl. No.: 19/314,417

(22) Filed: Aug. 29, 2025

Related U.S. Application Data
(60) Provisional application No. 63/688,847, filed on Aug. 29, 2024.

(51) Int. Cl. B62M 3/08

(52) U.S. Cl. CPC B62M 3/086

(57) ABSTRACT

A bicycle pedal assembly may include a pedal body with a rotation axis and a cleat region. A cleat binding assembly may include a first binding portion disposed at a first portion of the cleat region and a second binding portion longitudinally spaced apart from the first binding portion on a second side of the rotation axis. The cleat binding assembly may releasably retain a cleat A cleat support assembly may include a first support plate covering a first portion of the pedal body to bear against and support a first portion of the cleat when the cleat is retained. A second support plate may be disposed between the rotation axis and the second binding portion and spaced from the first support plate and may be configured to bear against and support a second portion of the cleat when the cleat is retained by the cleat binding assembly.

### CROSS-REFERENCE TO RELATED APPLICATION

This application is related to and claims priority to U.S. Provisional Application No. 63/688,847 entitled BICYCLE PEDAL ASSEMBLY and filed Aug. 29, 2024, the entirety of which is incorporated herein by reference.

### TECHNICAL FIELD

This application relates generally to a bicycle pedal assembly, and in particular a step-in or clipless pedal assembly.

### BACKGROUND

Cycling is increasingly popular for recreation, transportation, and as a competitive sport. The bicycle industry continually improves bicycle components and frames, including pedals. Pedal designs now cater to various purposes such as for pleasure riding, off-road biking, and road racing. Clipless pedals, which securely attach to cleats on cycling shoes, are a popular choice. These pedals feature mechanisms that engage cleats for efficient power transfer during pedaling.

U.S. Patent Application Publication No. 2012/0167711 discloses a clipless pedal with a modularized engagement mechanism for detachably securing with the cleat on a rider's shoe. The engagement structure includes a fixing seat, an annular frame, a depressor, two torsion springs, a shaft, and a regulator bolt. The fixing seat is pivotally connected on the annular frame by inserting the shaft. The two torsion springs are put around the shaft. The depressor has a threaded hole in which the regulator bolt screws. By rotating the regulator bolt, the depressor can be linearly moved. Two ends of each the torsion separately bear against the fixing seat and depressor. The annular frame can be swung relative to the fixing seat when it is forced and restored by the torque from the torsion springs when it is not forced. The torque of the torsion springs can be regulated by linear movement of the depressor. The engagement mechanism can be fastened on a pedal body to form a clipless pedal.

U.S. Pat. No. 10,787,226 discloses a pedal that includes a pedal body and a step-in assembly. The step-in assembly has a projected area less than that of the pedal body and is fixed on a platform of the pedal body. The step-in assembly has a frame with a U-shape, a front fastener integrally formed at a closed end of the frame in one-piece, and a rear fastener pivotedly connected to an open end of the frame. A protrusion is aslant extended from each of two opposite sides of the frame. The two protrusions are symmetrically arranged to face to each other.

U.S. Pat. No. 6,453,771 discloses a bicycle pedal with a pedal shaft or spindle, a pedal body with at least one cleat engagement mechanism and a tread cage supporting a rider's foot for attaching a shoe thereto via a cleat. The bicycle pedal body and the tread cage are coupled together for rotation about the pedal shaft or spindle. The tread cage is at least partially constructed of a resilient material to allow deflection of the tread cage relative to the pedal body. The tread cage has a tread surface that is at least partially located above the cleat engagement mechanism such that the tread cage must be deformed for complete engagement of the cleat with the cleat engagement mechanism. The resilient material of the tread cage permits limited angular rotation between the pedal body and the cage such that the tread surface contacts the shoe of the shoe when the cleat is in complete engagement with the cleat engagement mechanism. Preferably, the pedal body has cleat engagement mechanism coupled to each side for releasably retaining a cleat of a bicycle shoe therein.

European Patent Application Publication No. 1,219,532 discloses a bicycle pedal that includes a pedal shaft, a pedal body, first and second clamping members and a first biasing member. The pedal body is rotatably mounted on the pedal shaft. The first clamping member has a first cleat engagement surface and is pivotally mounted, while the second clamping member has a second cleat engagement surface and is fixedly coupled to the pedal body. The second clamping member is configured to form an unobstructed passageway. Preferably, the second clamping member includes two outer attachment points and an inner attachment point. An adjustment member is arranged between the first clamping member and a biasing member to adjust tension of the biasing member on the first clamping member. The adjustment member has a head arranged in a hole of the first clamping member, an enlarged section and an adjustment plate adjustably mounted on the adjustment member.

U.S. Pat. No. 6,205,885 discloses a clipless bicycle with a latch release mechanism that is concentric to the spindle axis that allows cleat engagement on four sides of the pedal. The pedal includes a spindle with a thread on one end for attachment to a bicycle crank arm, a housing that rotates about the spindle on bearings, two U-shaped members that are affixed to opposite sides of the housing, two sleeves that slip over opposite ends of the housing allowing the sleeves to rotate concentrically about the axis of the spindle, two U-shaped members that are affixed to opposite sides of the sleeves, a torsion spring that is concentrically positioned over the housing such that it holds the U-shaped members that are attached to the housing perpendicular to the U-shaped members that are affixed to the sleeves, and a cleat for mounting on the bottom of a bicycling shoe that can releasably engage between any of the four adjacent pairs of U-shaped members. The spring has a coil axis that is coincident with the spindle axis. A threaded plug retains the housing assembly on the spindle. An O-ring seals the housing against the spindle on one end and another O-ring seals the housing against the plug on the other end. A spacer holds the spring in position. The housing, sleeves, bent wire members, spindle, and cleat are made of stainless steel, titanium, or some other material that has the strength and corrosion resistance required. The cleat has two shoulders that can engage under the bent U-shaped members.

Taiwan Patent Application Publication No. TW202030110 discloses a clipless bicycle pedal comprising an axle, connectable to a bicycle crank arm, and a locking mechanism, connected to the axle, suitable to engage/disengage a cleat assembly of a cycling shoe. The locking mechanism comprises a sleeve, inserted along the axle, an inner loop and an outer loop, inserted along the sleeve and free to rotate around the sleeve, so that the inner loop is contained within the outer loop. The locking mechanism further comprises a cam, included between the inner loop and the outer loop, suitable to hold the inner loop and the outer loop in an engagement configuration of the cleat assembly. The cam is also suitable to allow rotational movement of the inner, outer loops relative to each other, from the engagement configuration to a disengagement configuration of the cleat assembly.

U.S. Patent Application Publication No. 2017/0066499 discloses a bicycle pedal that includes a rotation axle; a pedal body movably coupled to the rotation axle and including an axle sleeve section, two hollowed areas, and a first retention block assembly and a second retention block assembly; first and second adjustment mechanisms respectively arranged in the hollowed areas and each including a fixing bolt arranged in the hollowed area, a holding seat fit over the fixing bolt and abutting one side of the first or second retention block assembly, an elastic element fit over the fixing bolt and having an end abutting one side of the second or first retention block assembly, and an adjustment section movably mounted to the holding seat and abutting an opposite end of the elastic element; and a clip block mounted, in a removable manner, between the first adjustment mechanism and the second adjustment mechanism.

Shimano® provides a pedal for trail riding, enduro, and mountain riding. The PD-M8120 enhances stability and bike control when pedaling and descending on the gnarliest of trails. Lower platform height and wide pedal-to-shoe contact promote stable and efficient pedaling. An integrated cage increases control even when un-clipped, and retention claws ensure smooth clip in and out.

### SUMMARY

It should be appreciated that this summary is provided to introduce a selection of concepts in a simplified form that are further described below in the detailed description. This summary is not intended to be used to limit the scope of the claimed subject matter.

In accordance with one broad aspect of the teachings described herein a bicycle pedal assembly may include a pedal body comprising a rotation axis and a first side configured to engage a foot of a user and including a cleat region. The pedal body may be rotatably mountable to a crank arm of a bicycle. A cleat binding assembly may include a first binding portion disposed at a first portion of the cleat region and on a first side of the rotation axis and a second binding portion longitudinally spaced apart from the first binding portion at a second portion of the cleat region and on a second side of the rotation axis. The cleat binding assembly may be configured to releasably retain a cleat so that when the cleat is retained within the cleat binding assembly the cleat is adjacent the first side of the pedal body and overlies the cleat region. A cleat support assembly may include a first support plate longitudinally spaced from the rotation axis and disposed between the rotation axis and the first binding portion. The first support plate may cover a first portion of the pedal body within the cleat region and may be configured to bear against and support a first portion of the cleat when the cleat is retained by the cleat binding assembly. A second support plate may be longitudinally spaced from the rotation axis and may be disposed between the rotation axis and the second binding portion, spaced apart from the first support plate. The second support plate may cover a second portion of the pedal body within the cleat region and may be configured to bear against and support a second portion of the cleat when the cleat is retained by the cleat binding assembly. The second support plate may be removable from the pedal body independently of the second binding portion.

The first support plate may be removable independently of the first binding portion.

The first support plate may include an inboard portion and an outboard portion that is axially spaced from the inboard portion.

A central portion may extend axially between and connect the inboard and outboard portions to provide a generally continuous first support surface.

The second support plate may include an inboard portion and an outboard portion that is axially spaced from the inboard portion.

The inboard portion and the outboard portion may be axially spaced apart from each other and may be configured to bear against and support a second portion of the cleat when retained by the cleat binding assembly.

A central portion may extend axially between and connect the inboard and outboard portions to provide a generally continuous second support surface.

An outer surface of the first support plate and an outer surface of the second support plate may define and lie in a common cleat support plane, which may be parallel to and spaced apart from the first side of the pedal body.

The second support plate may rest on a complimentary second support plate receiving surface on the first side of pedal body that is exposed when the second support plate is removed, the second support plate receiving surface may lie in and define a support plate receiving plane, which is parallel to the first side of the pedal body and in line with a bushing plane defined by a bushing within the pedal body.

The first support plate and second support plate may be longitudinally spaced apart from each other by a central offset region that extends over the rotation axis and has a longitudinal length that is at least 1 mm.

The longitudinal length may be between about 5 mm and about 10 mm.

In accordance with another broad aspect of the teachings described herein a bicycle pedal assembly may include a pedal body having a first side configured to engage a foot of a user and including a cleat region, an opposing second side and a mounting cavity extending along a rotation axis, bounded by a cavity inner sidewall and configured to receive a spindle portion of an axle whereby the pedal body is rotatably mountable to a crank arm of a bicycle. The pedal body may be divided by a first plane, having a first side and a second side, intersecting the pedal body along a length of the pedal body and the rotation axis. The pedal body may be divided by a second plane intersecting the pedal body at the rotation axis and perpendicular to the first plane, the second plane having a first side and a second side. At least a first support plate receiving surface may be disposed in the cleat region and offset from the rotation axis. A cleat binding assembly may include a first binding portion disposed at a first portion of the cleat region and on a first side of the first and second planes and a second binding portion longitudinally spaced apart from the first binding portion at a second portion of the cleat region and on the first side of the first plane and a second side of the second plane. The cleat binding assembly may be configured to releasably retain a cleat so that when the cleat is retained within the cleat binding assembly the cleat is adjacent the first side of the pedal body and overlies the cleat region. A first support plate may cover a first portion of the pedal body within the cleat region. The first support plate may include an inner surface that bears against the first support plate receiving surface and an opposing outer surface configured to contact and support a first portion of the cleat when the cleat is retained by the cleat binding assembly. A cavity plane that may be parallel to and spaced apart from the first plane and intersecting a portion of the cavity inner sidewall. A support plate receiving plane may be parallel to the first plane and may contain the first support plate receiving surface and is disposed between the cavity plane and the first plane.

The cavity plane may be defined by a portion of the cavity sidewall that is furthest from the first plane.

The cavity plane may be defined by a portion of the cavity sidewall that is adjacent to a bushing disposed within the cavity sidewall.

A second support plate may be receivable in a second support plate receiving surface. The second support plate may cover a second portion of the pedal body within the cleat region. The second support plate may include an inner surface that bears against the second support plate receiving surface and an opposing outer surface configured to contact and support a second portion of the cleat when the cleat is retained by the cleat binding assembly.

A distance between the first plane and the support plate receiving plane may be between about 4 mm and about 6 mm. The distance may be greater than 6 mm.

In accordance with another broad aspect of the teachings described herein, a bicycle pedal assembly may include a pedal body comprising a mounting cavity extending along a rotation axis, bounded by a cavity sidewall and configured to receive a spindle portion of an axle and a bushing. A first side may be configured to engage a foot of a user and may include a cleat region. An opposing second side may be spaced from the first side in a thickness direction that is orthogonal to the rotation axis. The pedal body may be rotatably mountable to a crank arm of a bicycle. The pedal body may have an upper most portion that is spaced farthest from the rotation axis in the thickness direction and defining a maximum height plane that is parallel to and spaced from the rotation axis in the thickness direction and intersects the upper most portion of the pedal body. A cleat binding assembly may include a first binding portion on a first side of the rotation axis and a second binding portion on a second side of the rotation axis and that is spaced apart from the first binding portion. The cleat binding assembly may be configured to releasably retain a cleat. A first contact surface may be disposed within the cleat region and may be configured to contact and support a first portion of the cleat when the cleat is retained by the cleat binding assembly. The first contact surface may lie in and define a cleat support plane that is between the rotation axis and the maximum height plane.

A first support plate may be connected to the pedal body and may cover a first portion of the pedal body within the cleat region, the first support plate comprising an outer surface that comprises the first contact surface and an opposing inner surface that bears against a first support plate receiving surface of the pedal body.

The first contact surface may be generally planar.

The first contact surface may be an elongate surface extending in the direction of the rotation axis.

The upper most portion may be outside of the cleat region.

The upper most portion may be inboard from the cleat region in the axial direction.

The upper most portion may be the most inboard portion of the pedal body.

The upper most portion may overlie the rotation axis.

A distance between the rotation axis and the cleat support plane may be between about 6 mm and about 8 mm.

A distance between the rotation axis and the maximum height may be greater than 8 mm.

### BRIEF DESCRIPTION OF THE DRAWINGS

Embodiments will now be described more fully with reference to the accompanying drawings, in which like reference numerals denote like parts throughout the several views, and in which:

FIG. 1 is a top plan view of a left-hand bicycle pedal assembly according to one embodiment;

FIG. 2 is a perspective view of the bicycle pedal assembly of FIG. 1;

FIG. 3 is cross sectional view of the bicycle pedal assembly of FIG. 1, taken along line A-A;

FIG. 4 is a plan view of the bicycle pedal assembly of FIG. 1 with a cleat retained;

FIG. 5 is cross sectional view of the bicycle pedal assembly of FIG. 4, taken along line D-D;

FIG. 6 is an enlarged, plan view of a portion of the bicycle peal assembly of FIG. 1;

FIG. 7 is cross sectional view of the bicycle pedal assembly of FIG. 1, taken along line C-C;

FIG. 8 is a perspective view of portions of the bicycle pedal assembly of FIG. 1;

FIG. 9 is a plan view of portions of the bicycle pedal assembly of FIG. 1;

FIG. 10 is a perspective view of the bicycle pedal assembly of FIG. 1 with an alternative cleat support assembly;

FIG. 11 is a plan view of a portion of the bicycle pedal assembly of FIG. 1 with a cleat engaged;

FIG. 12 is a side elevation view of a portion of the bicycle pedal assembly of FIG. 1; and

FIG. 13 is a side elevation view of an alternative portion of the bicycle pedal assembly.

### DETAILED DESCRIPTION

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example,” and similar language throughout the subject disclosure may, but do not necessarily, refer to the same example. Further, the subject matter characterizing any one example may, but does not necessarily, include the subject matter characterizing any other example.

Moreover, unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly connected” to, “directly coupled” with or “directly contacting” another element or feature, there are no intervening elements or features present.

It will be understood that spatially relative terms, such as “under”, “below”, “lower”, “over”, “above”, “upper”, “front”, “back”, “top”, “bottom”, “vertical”, “horizontal”, “upright” and the like, may be used herein for ease of description to describe the relationship of an element or feature to another element or feature as illustrated in the figures. The spatially relative terms can however, encompass different orientations in use or operation in addition to the orientation depicted in the figures.

Reference herein to “configured” denotes an actual state of configuration that fundamentally ties the element or feature to the physical characteristics of the element or feature preceding the phrase “configured to.”

Unless otherwise indicated, the terms “first,” “second,” etc. are used herein merely as labels, and are not intended to impose ordinal, positional, or hierarchical requirements on the items to which these terms refer.

As used herein, the terms “approximately”, “about”, “substantially”, “generally” and the like represent an amount close to the stated amount that still performs the desired function or achieves the desired result. For example, these terms may refer to an amount or orientation that is within engineering tolerances that would be readily appreciated by a person skilled in the art.

Bicycle pedals can come in variety of different designs and configurations, including flat pedals, pedals that utilize a toe clip (or strap) that extends over the top of the rider's foot and so-called step-in or clipless pedals that have a binding assembly that connects to a cleat or other such structure on the bottom of the rider's shoe to secure the rider's foot to the pedal. Several examples of clipless pedals are known to people familiar with the biking industry and utilize respective binding assemblies to selectably engage and disengage the cleat on a rider's shoe.

In general, it can be advantageous to reduce the overall size and/or weight of bicycle pedal, as it contributes to the overall weight of the bicycle (which some riders try to minimize). Thin pedals may also be relatively less likely to strike obstacles under or beside the bicycle while the bicycle is in use, as compared to relatively thicker pedals. This may help reduce the likelihood of the pedals becoming damaged or unbalancing the rider when riding on trails and other uneven surfaces. Reducing the weight of the bicycle pedal may also reduce the amount of material/metal that is required to form the pedal, which may help reduce manufacturing costs, shipping costs and the like. Relatively, small or thin pedals may also be perceived as having a premium or high-quality appearance which may be desirable to some riders. Despite the existence of clipless pedals that are currently on the market there remains a desire for thinner/smaller and lighter clipless pedal designs that may provide one or more of the advantages described herein. Accordingly, the inventors have designed a new bicycle pedal assembly.

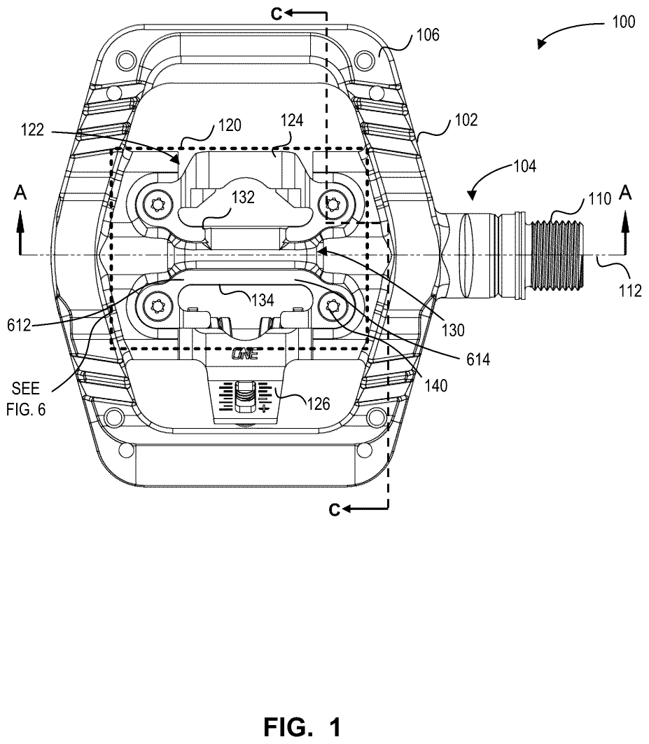

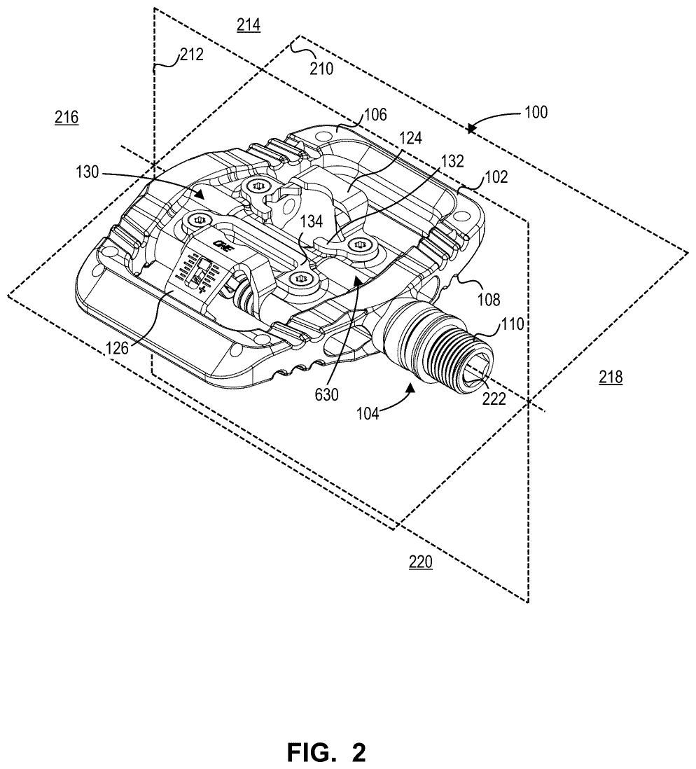

Referring now to FIGS. 1 and 2 one example of a bicycle pedal assembly is shown and is generally identified by reference numeral 100. The bicycle pedal assembly 100 has a pedal body 102 and a connection portion 104.

Bicycles, and pedals attached thereto, can be understood to generally define a forward and backward directions (sometimes described as being aligned with a longitudinal direction), with the handlebars and steerable wheel being at the front of the bicycle and the driven wheel being at the rear. This orientation can also then help define a left and right side of the bicycle and a side-to-side or generally lateral direction (as defined when facing in the forward direction) and can also define a generally up/down direction. In addition to the left/right or lateral direction, components such as pedals that are attached to the bicycle can be described with reference to an inboard (e.g., generally spaced closer to or toward the bicycle frame) and an outboard direction (e.g., generally spaced farther from or extending away from the bicycle frame). For ease of description some of these terms may be used to describe the bicycle pedal assembly 100 and the configuration of its features, but it is understood that these descriptions are not intended to limit the arrangement of the bicycle pedal assembly 100 relative to the bicycle or to the horizonal and/or vertical directions or other absolute frame of reference.

In this example, the pedal body 102 generally describes the portion of the pedal that is configured to generally underlie or engage/support the foot of the bicycle rider/user. It can have a generally laterally extending, platform type configuration as shown in this example, or may have a different shape in other embodiments/examples of a pedal. In contrast, the connection portion 104 is the portion of the pedal body 102 that is generally not intended to support the user's foot during normal pedaling. The connection portion 104 is separate from an axle system and is, in this example, formed as an extension from the portions of pedal body 102 that underlie the foot of the user. That is, the connection portion 104 projects/extends generally inwardly or in an inboard direction (i.e., toward the bicycle or crank arm) from the pedal body 102 and is configured to help connect the pedal assembly 100 to the crank arm (not shown) of a suitable bicycle. The connection portion 104 therefor can include any suitable connector/coupling portions that can help secure the pedal assembly 100 to the crank arm in a manner that can permit rotation of the pedal body 102 relative to the crank arm while the bicycle is in use and can resist the expected loads that will be exerted by a user when the pedal is in use.

In this example, the pedal body 102 has a first side 106 that can underlie the foot of a user and can be described as the upper side that is visible in FIGS. 1 and 2 as presently illustrated. The pedal body 102 also defines an opposing second side 108, which can be described as the lower side that is less visible in FIGS. 1 and 2 as presently illustrated. The terms upper and lower are used here for convenience only, and in some arrangements the first side 106 may be generally downward facing when the pedal 100 is in use and is not intended to limit the description of the pedal assembly 100 described herein. In this description many of the features of the pedal assembly 100 are described in relation to the first side 106 for convenience. In some examples the features described herein may only be included on one side of the pedal body 102. Alternatively, the pedal body 102 may have analogous features on both the first and second sides 106 and 108 and may be of a two-sided design. That is, features described in relation to the first side 106 in one embodiment may also be provided on the second side 108 in some other embodiments.

The pedal body 102 may have any desirable shape or arrangement that can accommodate the features described herein. For example, in the present embodiment the pedal body 102 is generally hexagonal in shape when viewed from above the first side 106 (as shown in FIG. 1) and may optionally include one or more cut-outs or voids to reduce the weight and/or thickness of the pedal body 102. Alternatively, in some cases, the shape of the pedal body 102 may generally rectangular or may have other shapes that are configured to allow the pedal body 102 to generally engage a foot of a user. The pedal body 102 may be formed from a variety of suitable materials including metal, such as aluminum, steel, titanium and alloys and mixtures of these metals or others, or optionally may be formed from non-metal materials such as composite materials (e.g., carbon fiber or the like), plastic or other materials that can handle the anticipated pedal forces and to which the other components described herein can be connected. In one preferred embodiment of the pedal assembly 100 the pedal body 102 is formed from an aluminum alloy.

The connection portion 104 is preferably configured to rotatably mount the pedal body 102 to a crank arm of a bicycle. The connection portion 104 is generally cylindrical in shape and has a connecting mechanism 110. In the illustrated example the connecting mechanism 110 includes a threaded portion that is configured to threadingly attach to the pedal assembly 100 to a corresponding threaded connector on the crank arm (not shown).

The pedal assembly 100 defines and is configured to rotate about a respective rotation axis that is illustrated as a rotation axis 112, about which the bicycle pedal assembly 100 rotates. In this example the rotation axis 112 extends along a centre of the bicycle pedal assembly 100 in the front/back or longitudinal direction as well as being generally centered relative to the pedal body in the thickness direction (e.g., the direction extending between the first side 106 and second side 108 of the pedal body and parallel to the second plane 212 as illustrated). The rotation axis 112 need not be precisely centered in these directions relative to the pedal body 102, and the pedal body 102 may be at least somewhat asymmetrical relative to the rotation axis 112 in some embodiments.

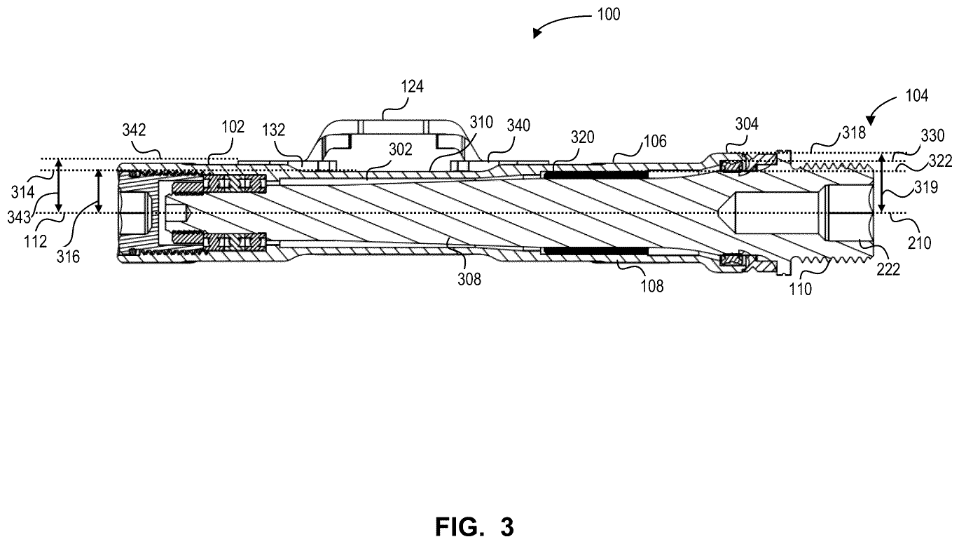

In this application, the bicycle pedal assembly 100 is also described with reference to a first plane 210 and a second plane 212. In this example, the first plane 210 dissects the pedal body 102 in a generally lateral/horizontal direction as illustrated in FIGS. 2 and 3 and extends between the first side 106 and second side 108 of the pedal body 102. That is, features on the first side 106 are on first side of the first plane 210 (above the plane 210 as illustrated in this example) and features on the second side 108 of the pedal body are located on an opposing, second side of the first plane 210 (below the plane 210 as illustrated in this example).

The second plane 212 is generally orthogonal to the first plane 210 and extends in a thickness direction which as illustrated in FIGS. 1 and 2, in a generally vertical direction in this illustrated example (but need not be vertical if the pedal assembly 100 is itself rotated relative to the horizonal/vertical direction). The second plane 212 has a first side and a second side and serves to divide the pedal body 102 into first and second portions in the longitudinal direction, which tends to be generally aligned with the front/back direction of the bicycle when the pedal assembly 100 is in use. In this arrangement, the first plane 210 and the second plane 212 intersect each other at a line of intersection that is parallel to and colinear with the rotation axis 112. That is, the rotation axis 112 extends along the intersection between the first plane 210 and second plane 212 in this example and lies within both planes. This arrangement of the first plane 210 and the second plane 212 can define four quadrants 214, 216, 218, and 220 about the pedal body 102. The first quadrant 214 includes the first side of the first plane 210 and the first side of the second plane 212. The second quadrant 216 includes the first side of the first plane 210 and the second side of the second plane 212. The third quadrant 218 includes the second side of the first plane 210 and the first side of the second plane 212. The fourth quadrant 220 includes the second side of the first plane 210 and the second side of the second plane 220. These quadrants and locations are used for clarity of discussion in the present description but are not limiting for any particular use of the pedal assemblies described herein.

Referring to FIG. 1, the pedal body 102 is illustrated as having a cleat region 120 denoted by the dashed line in FIG. 1. In general, the cleat region 120 is understood to be a portion of the pedal body 102 that is expected to underlie and contact/support the cleat on the shoe of a user when the pedal assembly 100 is in use. The cleat region 120 can therefore include/contain portions of the pedal body 102 material itself, holes/cut-outs or open regions and one or more surfaces that are configured and positioned to contact or bear against/support the cleat when the user is “clipped in” to the pedal assembly 100. This cleat region 120 also contains the cleat binding assembly 122 in this example, which includes the hardware that can selectably retain and release the cleat of a user. That is, the cleat binding assembly 122 is preferably configured to releasably retain a cleat on the user's shoe (not shown), so that when the cleat is retained within the cleat binding assembly 122 the cleat is generally proximate or adjacent the first side 106 of the pedal body 102 and generally occupies and overlies at least some of, and preferably a majority of the cleat region 120. Preferably, when the user is “clipped in” to the pedal assembly 100 the cleat on the user's shoe is contained within and does not extend substantially outside the perimeter of the cleat region 120, while other portions of the user's shoe/foot may extend outside the cleat region 120. In some cases, another cleat binding assembly 122 may be provided on the second side 108 of the pedal body 102. For the purposes of this application the cleat region 120 can be understood to have a first portion that is located on the first side of the second plane 212 (e.g., forward/to the right of the second plane 212 in the configuration shown in FIG. 2), and a second portion that is located on the second side of the second plane 212.

In the illustrated example, the cleat binding assembly 122 has a forward binding portion 124, that is located toward what would be considered the front and the top of the pedal assembly 100 when in use, and a rearward binding portion 126 that is separate from and spaced apart from the first binding portion 124 in the longitudinal direction and is located relatively closer to what would be considered the rear portion of the pedal assembly 100 when it is in use. In this arrangement, the forward binding portion 124 is connectable to the pedal body 102 on a forward side of the rotation axis 112 (e.g., on the first side of the plane 212) and is disposed within a first portion of the cleat region 120, the first portion of the cleat region 120 being forward of the rotation axis 112 or in the first quadrant 214. While the terms forward and rearward are used for convenience, it its understood that features described as being located at a “forward” location in this example may be provided in a rearward location in other embodiments of an analogous pedal assembly, and unless otherwise specified terms like “first binding portion” or “second binding portion” may be used to describe portions of the pedal assembly 100 that are located at forward or rearward positions in a given pedal assembly configuration. This understanding also applies to other portions of the pedal assemblies described herein.

The rearward binding portion 126 is also shown in FIG. 2 to be on the first side of the first plane 210 and the second side of the second plane 212. The rearward binding portion 126 is shown to be in the second quadrant 216. The rearward binding portion 126 is connectable to the pedal body 102 on a rearward side of the rotation axis 112. The rearward binding portion 126 is disposed at a second portion of the cleat region 120 and is spaced apart from the forward binding portion 124. The forward binding portion 124 and the rearward binding portion 126 are complimentary to each other and are configured to engage a suitable cleat.

In some arrangements, the forward binding portion 124 and the rearward binding portion 126 are in the first quadrant 214 and the second quadrant 216 respectively. In some cases, the forward binding portion 124 and the rearward binding portion 126 are in the second quadrant 216 and first quadrant 214 respectively. In some cases, the forward binding portion 124 and the rearward binding portion 126 are in the third quadrant 218 and the fourth quadrant 220 respectively. In some cases, the forward binding portion 124 and the rearward binding portion 126 are in the fourth quadrant 220 and the third quadrant 218 respectively.

In addition to the cleat binding assembly 122 the bicycle pedal assembly 100 also includes a cleat support assembly 130. While the cleat binding assembly 122 helps keep the cleat retained to the pedal assembly 100 the cleat support assembly 130 includes portions of the pedal assembly that are to be contacted by and/or bear against and receive force from the cleat when it is retained within the cleat binding assembly 122. In this arrangement the cleat support assembly 130 includes portions of the pedal assembly 100 that underlie and are registered beneath the contact surfaces of the cleat when it is retained. Optionally, the cleat support assembly 130 can include portions of the pedal assembly 100 that are integrally formed with the pedal body 102 or are provided on separate members that can be attached to the pedal body 102 and/or a combination of both. Because the cleat support assembly 130 includes portions of the pedal assembly 100 that will contact, and may be worn/damaged by contact with the cleat, it may be preferable for at least some, and optionally all of the cleat support assembly 130 to be provided by separate members that can be connected and disconnected from the pedal body 102, such that they can be repaired or replaced as needed/desired during the life cycle of the pedal assembly 100 (preferably without having to replace the rest of the pedal body 102 and/or the binding assembly 120). It may also be desirable for some portions of the cleat support assembly 130 to be replaceable independently of other portions of the cleat support assembly 130 for analogous reasons.

In this example, the cleat support assembly 130 includes a forward support plate 132 and a rearward support plate 134 that are spaced apart from each other in the longitudinal direction and are disposed on opposing sides of the rotation axis 112 and second plane 212. That is, in this example, the forward support plate 132 is on the first side of the rotation axis 112 and is longitudinally spaced apart from the rotation axis 112 and second plane 212. In this arrangement the forward support plate 132 is disposed longitudinally between the rotation axis 112 and the forward binding portion 124. The forward support plate 132 is shown in FIG. 2 to be on the first side of the first plane 210 and the first side of the second plane 212 and is therefore in the first quadrant 214. The forward support plate 132 covers/overlies a portion of the pedal body 102 (as described further herein) within the cleat region 120 and has an outer surface that is configured to bear against and support a first portion of the cleat when the cleat is retained by the cleat binding assembly 122. In some cases, the forward support plate 132 is integral with the forward binding portion 124. In some cases, the forward support plate 132 is independent of the forward binding portion 124.

The rearward support plate 134 is spaced from the forward support plate 132 and is on the second side of the rotation axis 112 and second plane 212. The rearward support plate 134 is longitudinally spaced from the rotation axis 112 and is disposed between the rotation axis 112 and the rearward binding portion 126. The rearward support plate 134 is spaced apart from the forward support plate 132 and covers/overlies another portion of the pedal body within the cleat region 120. The rearward support plate 134 is shown in FIG. 2 to be on the first side of the first plane 210 and the second side of the second plane 212 and is therefore in the second quadrant 216. The rearward support plate 134 has an outer surface that is configured to bear against and support a second portion of the cleat when the cleat is retained by the cleat binding assembly 122.

In this embodiment, the forward support plate 132 and rearward support plate 134 are separate from the pedal body 102 and can be attached thereto using any suitable fastening mechanism. Preferably, the forward support plate 132 and rearward support plate 134 are connected using a detachable fastener, such as a screw or bolt, so that they can be detached and replaced as needed/desired. In the illustrated example, the forward support plate 132 and the rearward support plate 134 are removably attachable to the pedal body 102 with fasteners 140. The fasteners 140 may be threaded fasteners such as screws or bolts or similar. The rearward support plate 134 is removable from the pedal body 102 independently of the rearward binding portion 126. This enables replacement of the rearward support plate 134 without dismantling the cleat binding assembly 122, and minimizes the materials used to minimize wear of the pedal body 102 during use, helping to reduce the overall weight of the bicycle pedal assembly 100. Optionally, the forward support plate 132 may be configured in an analogous manner such that it is removable independently from the front binding portion 124, and preferably independently from the rearward support plate 134. In some arrangements, the rearward support plate 134 may be removable independently from the rear binding assembly 126.

In some cases, the forward support plate 132 and the rearward support plate 134 may be in different quadrants 214, 216, 218 and 220 depending on the arrangement of a given pedal assembly 100.

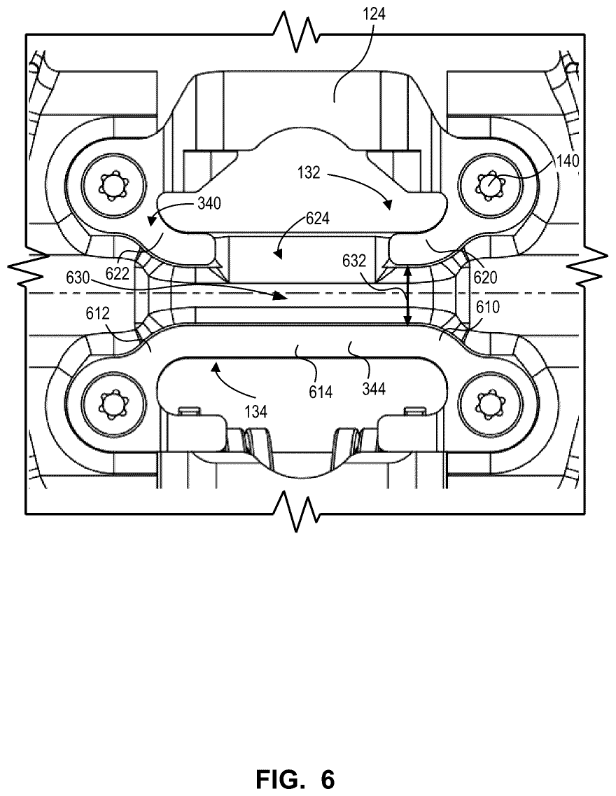

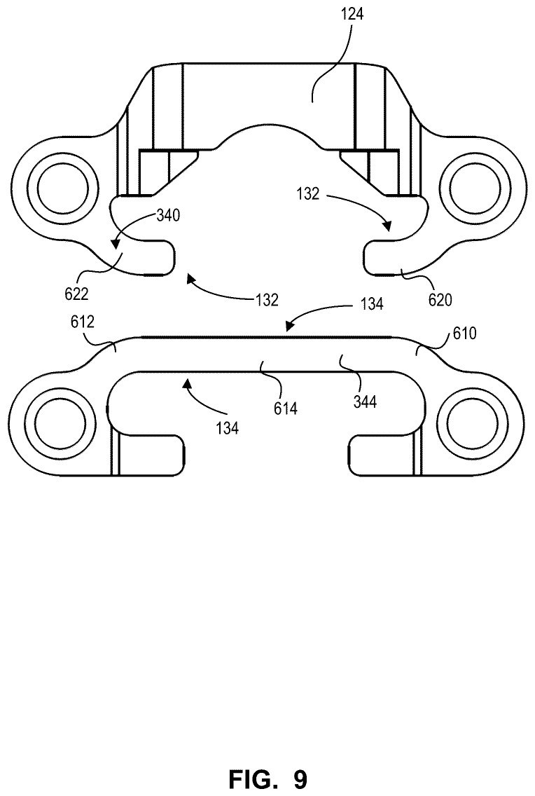

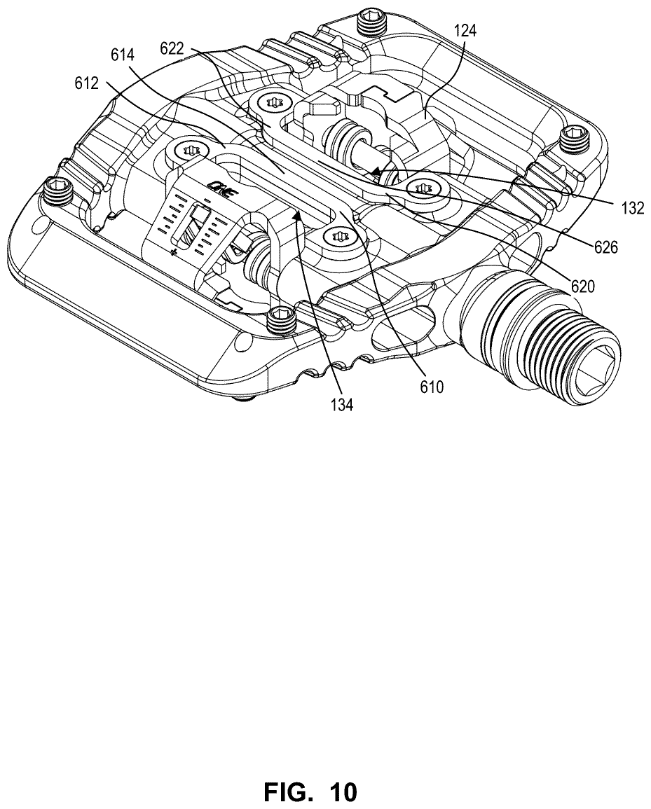

Referring also to FIG. 6 and FIG. 9, an enlarged, plan view of the forward support plate 132 and the rearward support plate 134 is provided. In this example, the forward support plate 134 has an outer surface 340 that includes an inboard portion 620 and an outboard portion 622. The inboard portion 620 and the outboard portion 622 are axially/laterally spaced apart from each other in the direction of the rotational axis 112 and there is a gap 624 disposed laterally between the inboard portion 620 and the outboard portion 622 in which the underlying material of the pedal body 102 is exposed but is recessed from the outer surface 340. In this embodiment, the inboard portion 620 and the outboard portion 622 are connected to each other by the first binding assembly 124 to help maintain their lateral spacing. In this arrangement the outer surface 340 provides two distinct support surfaces (the inboard portion 620 and the outboard portion 622) of the forward support plate 132 that contact laterally spaced apart regions of the cleat when it is retained in the cleat binding assembly 122. In some cases, the forward support plate 132 may include additional material 626 that spans the gap 624 to provide a central portion that extends axially between and connects the inboard portion 620 and the outboard portion 622, in a manner that is similar to the rearward support plate 134 described herein (e.g., FIG. 10). Such arrangements may provide a generally continuous outer surface 340 of the forward support plate 134 that contacts the cleat across at least most of its lateral width when it is retained in the cleat binding assembly 122.

Similarly, the rearward support plate 134 in the illustrated example has an outer surface 344 with an inboard portion 610 and an outboard portion 612 that are laterally/axially spaced apart from each other. This provides two support surfaces at the rearward support plate 134 that contact the cleat when it is retained in the cleat binding assembly 122. In this example, in contrast to the forward support plate 132, the rearward support plate 134 includes a central portion 614 that extends axially between and connects the inboard portion 610 and the outboard portion 612. This arrangement provides a generally continuous support surface at the rearward support plate 132 that contacts the cleat when it is retained in the cleat binding assembly 122.

The outer surfaces 340 and 344 of the forward support plate 132 and the rearward support plate 134, respectively, may have any suitable configuration but preferably, as in this example, are generally flat so as to provide generally flat/planar support surfaces. The generally planar support surfaces provided by the forward support plate 132 and the rearward support plate 134 are elongate and extend in a direction that, in this example, is parallel to and offset from the rotation axis 112 and to the first plane 210.

In the illustrated example, the forward support plate 132 and the rearward support plate 134 are longitudinally spaced apart from each other. Optionally, as shown in this example, the forward support plate 132 and the rearward support plate 134 can be configured such that they are not directly connected to each other. That is, the forward support plate 132 is connected to and supported by the pedal body 102, as is the rearward support plate 134, but they are not connected to each other in a functional/material manner other than by their mutual support by the underlying pedal body 102.

In this example, the forward support plate 132 and the rearward support plate 134 are longitudinally spaced apart separated from each other by a central offset region 630. The central offset region 630 is a generally central portion of the pedal body 102 that is longitudinally bounded by the forward support plate 132 and the rearward support plate 134 and extends over/overlies a portion of the pedal body 102 that covers and includes the rotational axis 112. In the illustrated example neither the forward support plate 132 and the rearward support plate 134 intersect the second plane 212 and do not overlie the rotational axis. Instead, preferably, the portions of the pedal body 102 that lie within the central offset region 630 are at a lower elevation than or recessed from the outer surfaces 340 and 344 of the forward support plate 132 and the rearward support plate 134. In other words, the portions of the pedal body 102 that lie within the central offset region 630 are closer to the first plane 210 than the outer surfaces 340 and 344 of the forward support plate 132 and the rearward support plate 134. In such configurations, the central offset region 630 can be a lowered or somewhat depressed region that tends to not be contacted by the cleat when a user is clipped in. That is, in the illustrated example, when the cleat is retained by the cleat binding assembly 122, the lower surfaces of the cleat remain spaced apart from and generally to not contact the pedal body 102 or other structure within the central offset region 630 and is not directly supported by or within the central offset region 630.

The central offset region has a longitudinal length 632 (FIG. 6) which can be, in some cases, at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm or more. In some cases, the longitudinal length 632 can be between about 2 mm and about 12 mm, and about 5 mm and about 10 mm. In the present application “about” is intended to mean a range of values that will not affect the material performance or intended function of the described features. With regard to the longitudinal length, “about” could be plus or minus 1 mm on the described ranges and still be considered to operate as intended. Configuring the central offset region 630 may allow the portions of the pedal body 102 that house the rotational axis 112 to be relatively thinner (in the thickness direction) as compared to a configuration in which portions of one or both of the forward support plate 132 and the rearward support plate 134 were configured to overlie the rotational axis 112.

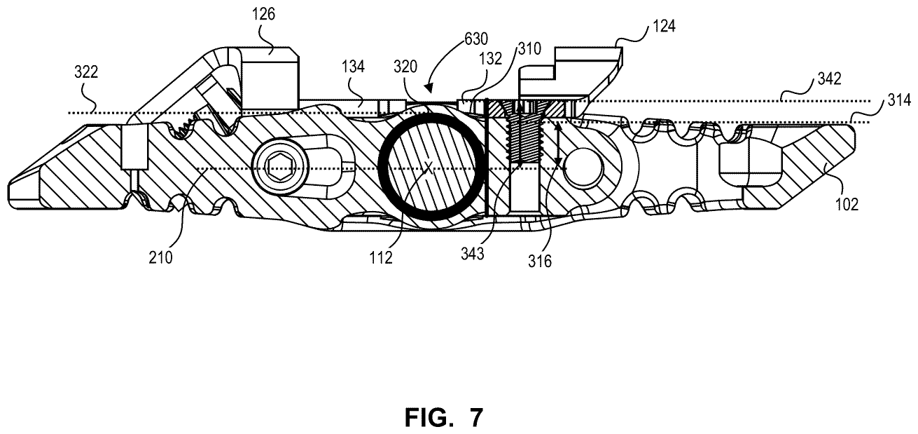

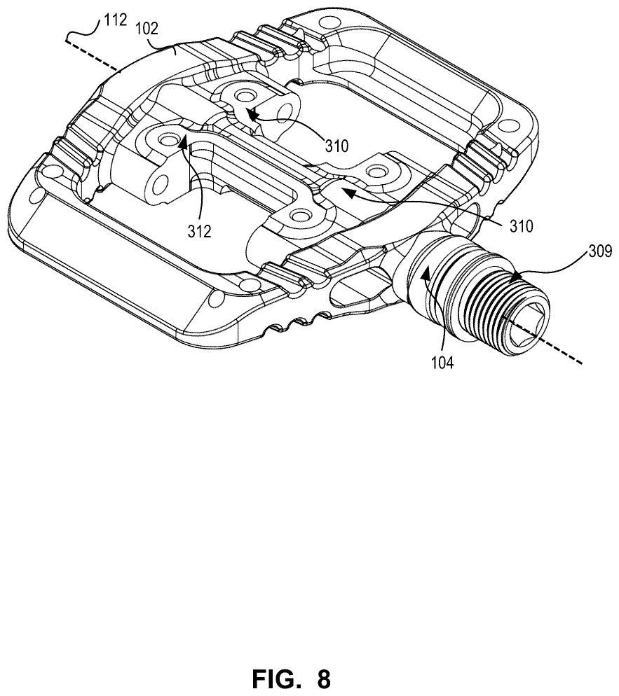

Turning now to FIG. 3, a cross sectional view of the bicycle pedal assembly 100 is shown taken along the line A-A, which coincides with the rotation axis 112 and/or the first plane 210. Referring also to FIGS. 7 and 8, the pedal body 102 in this example includes a forward support plate receiving surface 310 to receive and support the forward support plate 132, and a rearward support plate receiving surface 312 to receive and support the rearward support plate 134. In this example, the rearward support plate 134 is removable, independently of the rearward binding portion 126, and when it is removed the rearward support plate receiving surface 312 is exposed. Similarly, when the forward support plate 132 is removed, preferably independently from the forward support plate 132, the forward support plate receiving surface 310 is exposed as shown in FIG. 8.

The forward and rearward support plate receiving surfaces 310 and 312 are, in this example, configured as generally flat/planar surfaces that a complimentary to the design of their respective support plates 132 and 134. Preferably, as illustrated, the forward and rearward support plate receiving surfaces 310 and 312 are positioned to be generally coplanar with each other and can define a support plate receiving plane 314, which is preferably at least substantially parallel to, but offset from the first plane 210. In this arrangement, the support plate receiving plane 314 can be the lowest portion of the pedal body 102 relative to the first plane 210. The forward and rearward support plates 132 and 134 are mounted at, and bear against, the forward support plate receiving surface 310 and the rearward support plate receiving surface 312 respectively. A lower surface (not shown) of each of the forward support plate 132 and the rearward support plate 134 contact the forward support plate receiving surface 310 and the rearward support plate receiving surface 312 respectively. A distance 316 (FIG. 3) between the first plane 210 and the support plate receiving plane 314 can be between 3 mm and 7 mm, and preferably is between about 4 mm and about 6 mm, and may be 4, 4.5, 5, 5.5, or 6 mm or greater than 6 mm. In some cases, the distance 316 between the first plane 210 and the support plate receiving plane 314 is between 5 mm and 10 mm. Preferably the distance 316 is about 5.5 mm.

In the illustrated arrangement, the outer surfaces 340 and 344 of the forward support plate 132 and the rearward support plate 134 provide the contact surface to contact and support the respective forward and rearward portions of the cleat when the cleat is retained by the cleat binding assembly 122. The outer surfaces 340 and 344 of the forward support plate 132 and the rearward support plate 134, respectively, lie in a common cleat support plane 342. The cleat support plane 342 is parallel to, and spaced apart from, the rotation axis 112 and the first plane 210.

The pedal body 102 also has an uppermost portion 304 that, with the exception of the cleat binding assembly 122, is spaced farthest from the first plane 210 in the thickness direction and defines a maximum height/thickness of the pedal body 102 relative to the first plane 210. Preferably, the uppermost portion 304 is not located within the cleat region 120 and more preferably may be located axially inboard from the cleat region 120. In some cases, the uppermost portion 304 is the most inboard portion of the pedal body 102. The uppermost portion 304 overlies the rotation axis 112. A maximum height plane 318 is defined as being the farthest plane of the pedal body 102, without the cleat binding assembly 122, from the first plane 210 that intersects the upper position portion 304 and that is parallel to the first plane 210. A distance 319 (FIG. 3) between the maximum height plane 318 and the first plane 210 is greater than the distance 316 and can be between about 7.5 mm and about 9.5 mm, and preferably is between about 8 mm and about 9 mm. Ideally, the distance 319 is about 8.625 mm.

To help facilitate mounting to the crank arm, the pedal body 102 includes a generally axially extending mounting cavity that has an inner side wall 302 (FIG. 3). The cavity is configured to receive a spindle portion 308 of an axle 309 and preferably can also house a suitable rotational support element, such as a bearing, bushing or the like that can help support the pedal body 102 and permit rotation of the pedal body 102 relative to the spindle portion 308. In this example, the pedal assembly includes a bushing 320 that is disposed within the cavity, radially between the spindle portion 308 and the inner side wall 302.

In this arrangement, a cavity plane 330 is defined as being a plane that is parallel to the first plane 210 and intersects the inner side wall 302 at a location furthest from the first plane 210. In the illustrated example the cavity has a generally round, axial cross-sectional shape and the cavity plane 330 is a plane that is tangent to the upper most portion of the sidewall 302 (as illustrated in FIG. 3). The pedal body 102 is preferably configured so that cavity plane 330 is between the first plane 210 and the maximum height plane 318 in the thickness direction.

At a location further outboard within the cavity a bushing plane 322 is defined that is parallel to the first plane 210 and extends through the location where the outer surface of the bushing 320 contacts inner side wall 302 of the cavity. This bushing plane 322 is located between the support plate receiving plane 314 and the cavity plane 330 and/or maximum height plane 318.

In this arrangement, when the cleat is retained in the cleat binding assembly 122, the cleat contacts the forward support plate 132 and the rearward support plate 134. The cleat does not contact the pedal body 102 other than in the cleat binding assembly 122 and the forward support plate 132 and the rearward support plate 134. Preferably, the cleat is not in contact with or does not bear against the central offset region 630.

In this illustrated example, the support plate receiving plane 314 is between the first plane 210 and the cleat support plane 342. The support plate receiving plane 314 is between the maximum height plane 318 and the bushing plane 322. The bushing plane 322 is higher than and parallel to the first plane 210. In this arrangement the support plate receiving plane 314 is closer to the first plane 210 than the bushing plane 322. For example, the distance between the support plate receiving plane 314 and the first plane 210 may be about 5.5 mm in some examples, while the distance between the bushing plane 322 and the first plane 210 may be greater than 5.5 mm, and optionally may be 6 mm or more. In the illustrated example, the cavity plane 330 is higher than and parallel to the support plate receiving plane 314. In the illustrated example, the maximum height plane 318 is higher than and parallel to the cleat support plane 342.

Turning now to FIG. 12, a side elevation view of forward binding portion 124 is shown in isolation (i.e., separated from the pedal body and cleat). As can be seen in this view, in this example the inboard portion 620 and outboard portion 622 are each configured as relatively flat plates and the inboard portion 620 and the outboard portion 622 of the forward support plate 132 are generally in line with each other (i.e., at the same elevation as viewed in FIG. 12). Each of the inboard portion 620 and the outboard portion 622 of the forward support plate 132 provides a respective portion of the outer surface 340 which contacts the cleat 410 when it is engaged. Each of the inboard portion 620 and the outboard portion 622 of the forward support plate 132 has a lower or inward facing surface 1210 which faces and, in the present examples, contacts the forward support plate receiving surface 310 on the pedal body. In this example, the outer surfaces 340 are generally flat/planar surfaces and are coplanar with each other, and the inward facing surfaces 1210 are also generally flat/planar surfaces and are coplanar with each other, and generally parallel to the opposing outer surfaces 340.

The forward binding portion 124 includes an upper portion having an underside surface 1212 and an outer surface 1214. The upper portion is higher than the forward support plate 132. The outer surface 1214 is higher than the underside surface 1212 The underside surface 1212 is higher than the outer surface 340 of the forward support plate 132. The outer surface 340 is higher than the lower surface 1210. Although these surfaces are described with reference to the forward binding portion 124, it is appreciated the surfaces and arrangements are also applicable to the rearward binding portion 126.

In this arrangement, the lower surface 1210 of each of the forward support plate 132 and the rearward support plate 134 contact the forward support plate receiving surface 310 and the rearward support plate receiving surface 312 respectively. In this example, the lower surfaces 1210 of each of the forward support plate 132 and the rearward support plate 134 will lie in the support plate receiving plane 314 when connected to the pedal body, such that the lower surfaces 1210 can also be used to define the location of the support plate receiving plane 314 when the forward support plate 132 (and analogously, the rearward support plate 134) is connected to the pedal body.

Each of the forward support plate 132 and the rearward support plate has a thickness 1220 that is defined by the distance between the lower surface 1210 and the outer surface 340. When the forward support plate 132 and the rearward support plate 134 are in the illustrated configuration the thickness 1220 will be generally the same as the distance between the support plate receiving plane 314 (containing the lower surfaces 1210) and the cleat support plane 342 (containing the outer surfaces 340). The thickness 1220 may be any suitable thickness, and in the illustrated examples is preferably between about 1 mm and about 3 mm, but may be less than 1 mm or greater than 3 mm in some embodiment. More preferably, the thickness 1220 may be between about 1.5 mm and about 2.5 mm, and optionally may be about 2 mm in some examples.

Preferably, the support plate receiving surface 312 and the outer surface 340 of the forward support plate 132 and the rearward support plate 134 are both below the maximum height plane 318.

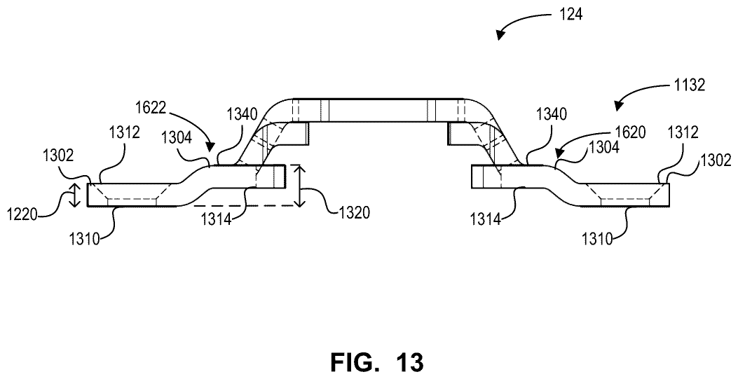

As noted above, these support plate arrangements are described with reference to the forward support plate 132 and the rearward support plate 134 that are generally planar, however other arrangements are possible. In some cases, one or both of the forward support plate 132 and the rearward support plate 134 need not be generally planar as shown in FIG. 12, and may have curved, stepped, bent or otherwise configured while still enabling the desired relations between the respective planes, contact surfaces, pedal body and cleat, etc. as described herein. For example, in one alternative configuration one or both of the forward support plate 132 and the rearward support plate 134 may have a raised portion that extends upwardly, away from the pedal body. Turning now to FIG. 13, a side elevation view of the forward binding portion 124 with an alternate forward support plate 1132 is shown.

In this alternative example, the forward support plate 1132 has an inboard portion 1620 and an outboard portion 1622. Both the inboard portion 1620 and the outboard portion 1622 have a respective outer surface 1340 may contact and bear against the cleat 410 when it is retained by the cleat binding assembly, or alternatively may be disposed within an open, central region of the cleat and may not contact the cleat directly when in use. The forward support plate 1132 in this example also defines a lower portion 1302 (configured to contact the pedal body) and a raised portion 1304 (which can optionally be spaced away from the pedal body). The lower portion 1302 has a lower surface 1310 and an upper surface 1312. The lower surface 1310 is receivable in the forward support plate receiving surface 310. In this arrangement the lower surface 1310 is in line with the support plate receiving plane 314. The lower portion 1302 also has an upper surface 1312. Optionally, in some embodiments using this version of the forward support plate 1132 the cleat 410 does not contact or bear against the upper surface 1312. The distance between the lower surface 1310 and the upper surface 1312 defines a thickness 1220. The thickness 1220 of the lower portion 1302 in the illustrated examples is preferably between about 1 mm and about 3 mm, but may be less than 1 mm or greater than 3 mm in some embodiment. More preferably, the thickness 1220 may be between about 1.5 mm and about 2.5 mm, and optionally may be about 2 mm in some examples. The upper region 1304 has a lower surface 1314 and the upper surface 1340 which contacts and bears against the cleat 410. In some cases, the lower surface 1314 is spaced apart from and does not contact the pedal body 102. In some cases, the lower surface 1314 contacts a portion of the pedal body 102. The distance between the outer surface 1340 and the lower surface 1310 defines a thickness 1320. The thickness 1320 will, in the examples illustrated, be at least as thick as the plate thickness 1220 (i.e., if the plate were flat as in FIG. 12 it may have a common thickness) and in the example illustrated will be greater than the distance 1220. In some examples the thickness 1320 may be between about 1 and 2 times the thickness 1220, and optionally may be more than twice the thickness 1220 in some examples. For example, the thickness 1320 may be between about 0 mm and about 3 mm more than the thickness 1220, and may be at least about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9 and 3 mm greater than the thickness 1220. Depending on the thickness 1220, the overall thickness represented by thickness 1320 as illustrated may, in some examples, be between about 2 mm and about 6 mm, and may be between about 3 mm and 5 mm, and in some example may be about 4 mm. The outer surface 1340, is below the maximum height plane 318 despite being raised. In an arrangement like this, the lower most surfaces 1310 on the forward support plate 1132 may lie in and at least partially define the support plate receiving plane 314, while the surface 1314 may be located at a different elevation.

Although these surfaces are described with reference to the forward binding portion 124, it is appreciated the surfaces and arrangements are also applicable to the rearward binding portion 126.

Preferably, the support plate receiving plane 314 lies between the first plane 210 and the maximum height plane 318 in the thickness direction. The support plate receiving plane 314 can also lie between the first plane 210 and the cavity plane 330 in the thickness direction. In some cases, a distance 343 (FIGS. 3 and 7) between the first plane 210 or the rotation axis 112 and the cleat support plane 342 can be generally between about 6 mm and about 8 mm, or may be 6, 6.5, 7, 7.5, or 8 mm or greater than 8 mm.

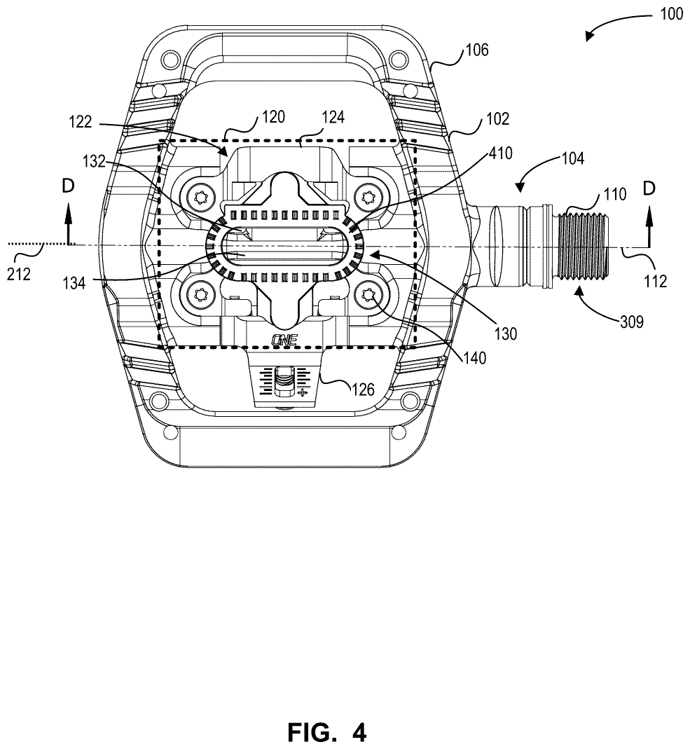

Turning now to FIG. 4, a plan view of the bicycle pedal assembly 100 is shown with one example of a cleat 410 retained within the cleat binding assembly 122. The remainder of the user's shoe has been omitted from the drawing for clarity to show the position of the cleat 410 relative to the pedal assembly 100, but would otherwise overlie portions of the pedal assembly 100. In this figure the cleat 410 is retained within the forward binding portion 124 and the rearward binding portion 126. The cleat 410 is held in position adjacent to the first side 106 of the pedal body 102 and is disposed within the perimeter of and overlies portions of the cleat region 120. In this arrangement the cleat 410 spans across both sides of the rotation axis 112, and would be intersected by the second plane 212.

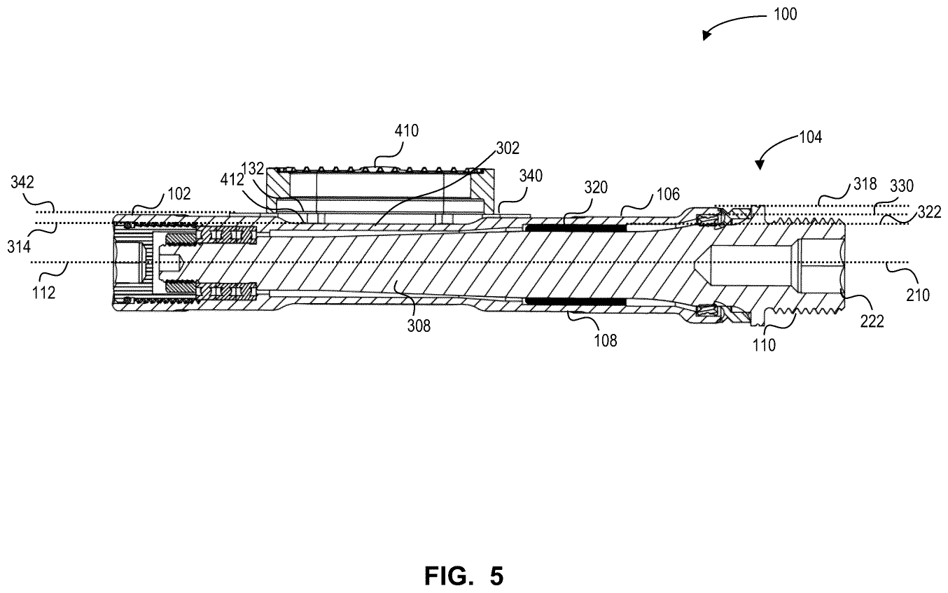

Turning now to FIG. 5, a cross sectional view of the bicycle pedal assembly 100 is shown taken along the line D-D, which coincides with the rotation axis 112 and/or the first plane 210, with the cleat 410 retained within the cleat binding assembly 122. In this arrangement the cleat 410 is shown in contact with the respective opposing outer surfaces 340 and 344 of the forward support plate 132 and the rearward support plate 134, respectively. A bottom surface 412 of the cleat 410 rests on the outer surface 340 and within the cleat support plane 342 in this arrangement. The bottom surface of the cleat 410 is not, in this example, in contact with or supported by the pedal body 102 in the central offset region 630.

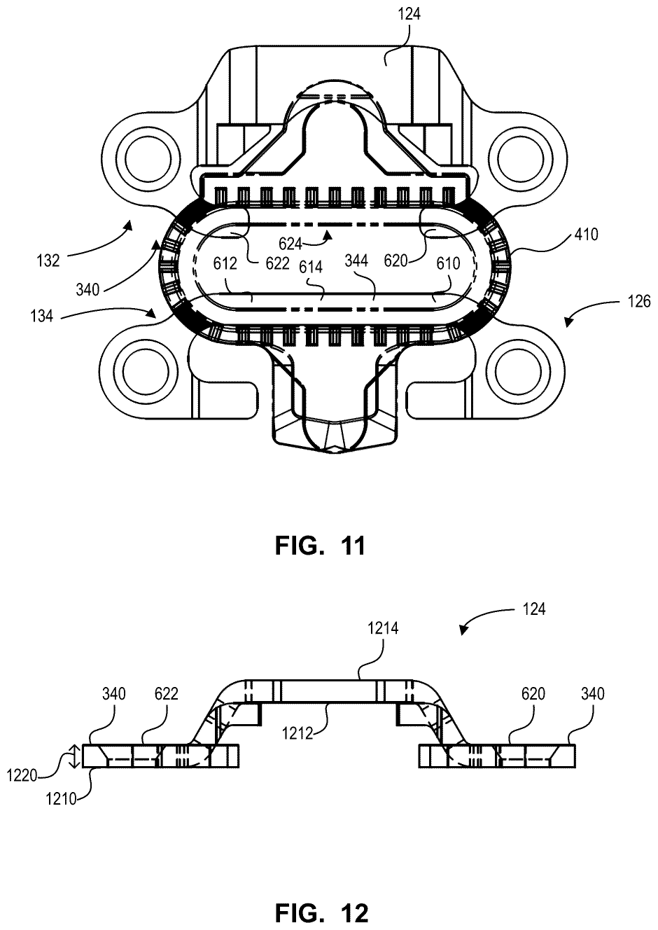

Turning now to FIG. 11, a plan view of a portion of the bicycle pedal assembly 100 with the cleat 410 engaged is shown. The cleat 410 overlies a portion of the forward support plate 132 and a portion of the rearward support plate 134. The cleat 410 is in contact with and bears against the inboard portion 620 and the outboard portion 622 of the forward support plate 132. The cleat 410 is spaced apart from the pedal body 102 at the gap 624 and does not make contact with or bear against the pedal body 102. In some configurations of the teachings described herein the cleat 410 can be in contact with and bear against the inboard portion 610 and the outboard portion 612 of the rearward support plate 134. Optionally, in some examples the cleat 410 may also be also in contact with and bear against the central portion 614 of the rearward support plate 134. In some other examples, the direct contact between the cleat and the forward support plate 132 and a portion of the rearward support plate 134 may be limited to four spaced apart contact regions (identified with solid black shading in FIG. 11, and may not be in direct contact with other portions of the support plates).

The bicycle pedal assemblies described herein may provide a desired means of retaining a cleat while helping to reduce contact between the cleat and the pedal body material, but instead contacting the support plates. As a result the support plates are worn down through use before the pedal body is damaged. The removable nature of the support plates, particularly in relation to the cleat binding assembly, enables efficient replacement of the support plates without a requirement to dismantle the whole pedal assembly.

While the forward and rearward support plates 132 and 134 providing the outer support surfaces 340 and 344 are illustrated as both being separate members that are removably attached to the pedal body 102, it is possible in some embodiments of the pedal assembly that either one of, or optionally both of, the support plates could be provided by portions of the pedal body 102 and need not be removable. That is, one or both of the outer support surfaces 340 and 344 could, in some examples, be integrally formed with the pedal body 102. While this may not permit removal of the outer support surfaces 340 and 344 for replacement or maintenance, such pedals may still have advantages relative to conventional pedal designs because of the location and arrangement of the outer support surfaces 340 and 344 and the planes and relative thicknesses, etc. described herein.

Although the binding portions of the cleat binding assembly are described as being a forward binding portion and a rearward binding portion, these are terms used for clarity and in relation to the examples shown in FIGS. 1 to 8, and are not intended to be limiting. For example, the forward binding portion may be a first binding portion and the rearward binding portion may be a second binding portion. In some cases, the forward binding portion may be the second binding portion and the rearward binding portion may be the first binding portion.

Although the support plates of the cleat support assembly are described as being a forward support plate and a rearward support plate, these are terms used for clarity and in relation to the examples shown in FIGS. 1 to 8, and are not intended to be limiting. For example, the forward support plate may be a first support plate and the rearward support plate may be a second support plate. In some cases, the forward support plate may be the second support plate and the rearward support plate may be the first support plate.

Although the support plate receiving planes are described as being a forward support plate receiving plane and a rearward support plate receiving plane, these are terms used for clarity and in relation to the examples shown in FIGS. 1 to 8, and are not intended to be limiting. For example, the forward support plate receiving plane may be a first support plate receiving plane and the rearward support plate receiving plane may be a second support plate receiving plane. In some cases, the forward support plate receiving plane may be the second support plate receiving plane and the rearward support plate receiving plane may be the first support plate receiving plane.

Although in the embodiments described above the rearward support plate is described as being removable from the pedal body independently from the rearward binding portion, other configurations are possible. In some cases, the forward support plate is removable from the pedal body independently from the forward binding portion. In some cases, both the forward support plate and the rearward support plate are removable independently from the forward binding portion and the rearward binding portion respectively.

Although the embodiments described above are generally in reference to the first side of the pedal body, other arrangements are possible. For example, the second side of the pedal body is generally identical to the first side of the pedal body and can accommodate the cleat binding assembly and the cleat support assembly. All documents and publications mentioned herein are incorporated by reference herein in their entirety.

1. A bicycle pedal assembly comprising:
a pedal body comprising a rotation axis and a first side configured to engage a foot of a user and including a cleat region, the pedal body being rotatably mountable to a crank arm of a bicycle;
a cleat binding assembly, comprising a first binding portion disposed at a first portion of the cleat region and on a first side of the rotation axis and a second binding portion longitudinally spaced apart from the first binding portion at a second portion of the cleat region and on a second side of the rotation axis, the cleat binding assembly configured to releasably retain a cleat so that when the cleat is retained within the cleat binding assembly the cleat is adjacent the first side of the pedal body and overlies the cleat region; and
a cleat support assembly comprising:
a first support plate longitudinally spaced from the rotation axis and disposed between the rotation axis and the first binding portion, the first support plate covering a first portion of the pedal body within the cleat region and being configured to bear against and support a first portion of the cleat when the cleat is retained by the cleat binding assembly; and
a second support plate longitudinally spaced from the rotation axis and disposed between the rotation axis and the second binding portion, spaced apart from the first support plate, the second support plate covering a second portion of the pedal body within the cleat region and being configured to bear against and support a second portion of the cleat when the cleat is retained by the cleat binding assembly, the second support plate being removable from the pedal body independently of the second binding portion.

2. The bicycle pedal assembly of claim 1, wherein the first support plate is removable independently of the first binding portion.

3. The bicycle pedal assembly of claim 1, wherein the first support plate comprises an inboard portion and an outboard portion that is axially spaced from the inboard portion.

4. The bicycle pedal assembly of claim 3, further comprising a central portion that extends axially between and connects the inboard and outboard portions to provide a generally continuous first support surface.

5. The bicycle pedal assembly of claim 3, wherein the second support plate comprises an inboard portion and an outboard portion that is axially spaced from the inboard portion.

6. The bicycle pedal assembly of claim 5, wherein the inboard portion and the outboard portion are axially spaced apart from each other and configured to bear against and support a second portion of the cleat when retained by the cleat binding assembly.

7. The bicycle pedal assembly of claim 5, further comprising a central portion that extends axially between and connects the inboard and outboard portions to provide a generally continuous second support surface.

8. The bicycle pedal assembly of claim 1, wherein an outer surface of the first support plate and an outer surface of the second support plate define and lie in a common cleat support plane, which is parallel to and spaced apart from the first side of the pedal body.

9. The bicycle pedal assembly of claim 1, wherein the second support plate rests on a complimentary second support plate receiving surface on the first side of pedal body that is exposed when the second support plate is removed, the second support plate receiving surface lies in and defines a support plate receiving plane, which is parallel to the first side of the pedal body and in line with a bushing plane defined by a bushing within the pedal body.

10. The bicycle pedal assembly of claim 1, wherein the first support plate and second support plate are longitudinally spaced apart from each other by a central offset region that extends over the rotation axis and has a longitudinal length that is at least 1 mm.

11. (canceled)

12. A bicycle pedal assembly comprising:
a pedal body comprising:
a first side configured to engage a foot of a user and including a cleat region, an opposing second side and a mounting cavity extending along a rotation axis, bounded by a cavity inner sidewall and configured to receive a spindle portion of an axle whereby the pedal body is rotatably mountable to a crank arm of a bicycle,
wherein the pedal body is divided by a first plane, having a first side and a second side, intersecting the pedal body along a length of the pedal body and the rotation axis, and wherein the pedal body is divided by a second plane intersecting the pedal body at the rotation axis and perpendicular to the first plane, the second plane having a first side and a second side, and
at least a first support plate receiving surface disposed in the cleat region and offset from the rotation axis;
a cleat binding assembly, comprising a first binding portion disposed at a first portion of the cleat region and on a first side of the first and second planes and a second binding portion longitudinally spaced apart from the first binding portion at a second portion of the cleat region and on the first side of the first plane and a second side of the second plane, the cleat binding assembly configured to releasably retain a cleat so that when the cleat is retained within the cleat binding assembly the cleat is adjacent the first side of the pedal body and overlies the cleat region;
a first support plate covering a first portion of the pedal body within the cleat region, the first support plate comprising an inner surface that bears against the first support plate receiving surface and an opposing outer surface configured to contact and support a first portion of the cleat when the cleat is retained by the cleat binding assembly;
a cavity plane that is parallel to and spaced apart from the first plane and intersecting a portion of the cavity inner sidewall; and
a support plate receiving plane that is parallel to the first plane and contains the first support plate receiving surface and is disposed between the cavity plane and the first plane.

13. The bicycle pedal assembly of claim 12, wherein the cavity plane is defined by a portion of the cavity inner sidewall that is furthest from the first plane.

14. The bicycle pedal assembly of claim 13, wherein the cavity plane is defined by a portion of the cavity inner sidewall that is adjacent to a bushing disposed within the cavity inner sidewall.

15. The bicycle pedal assembly of claim 12, wherein a second support plate is receivable in a second support plate receiving surface, the second support plate covering a second portion of the pedal body within the cleat region, the second support plate comprising an inner surface that bears against the second support plate receiving surface and an opposing outer surface configured to contact and support a second portion of the cleat when the cleat is retained by the cleat binding assembly.

16. (canceled)

17. (canceled)

18. A bicycle pedal assembly comprising:
a pedal body comprising a mounting cavity extending along a rotation axis, bounded by a cavity sidewall and configured to receive a spindle portion of an axle and a bushing, a first side configured to engage a foot of a user and including a cleat region, an opposing second side spaced from the first side in a thickness direction that is orthogonal to the rotation axis, whereby the pedal body is rotatably mountable to a crank arm of a bicycle, the pedal body having an upper most portion that is spaced farthest from the rotation axis in the thickness direction and defining a maximum height plane that is parallel to and spaced from the rotation axis in the thickness direction and intersects the upper most portion of the pedal body; and
a cleat binding assembly, comprising a first binding portion on a first side of the rotation axis and a second binding portion on a second side of the rotation axis and spaced apart from the first binding portion, the cleat binding assembly configured to releasably retain a cleat,
a first contact surface disposed within the cleat region and configured to contact and support a first portion of the cleat when the cleat is retained by the cleat binding assembly, the first contact surface lying in and defining a cleat support plane that is between the rotation axis and the maximum height plane.

19. The bicycle pedal assembly of claim 18, further comprising a first support plate connected to the pedal body and covering a first portion of the pedal body within the cleat region, the first support plate comprising an outer surface that comprises the first contact surface and an opposing inner surface that bears against a first support plate receiving surface of the pedal body.

20. (canceled)

21. (canceled)

22. The bicycle pedal assembly of claim 18, wherein the upper most portion is outside of the cleat region.

23. The bicycle pedal assembly of claim 18, wherein the upper most portion is inboard from the cleat region in an axial direction.

24. The bicycle pedal assembly of claim 18, wherein the upper most portion is the most inboard portion of the pedal body.

25. The bicycle pedal assembly of claim 18, wherein the upper most portion overlies the rotation axis.

26. (canceled)

27. (canceled)
